(19) United States
(12) Patent Application Publication
(10) Pub. No.: US 2005/0057764 A1
(43) Pub. Date: Mar. 17, 2005

(54) Graphic POS printer

(76) Inventors: Andrew Kobziar, Ithaca, NY (US); Terrence J. Campbell, Ithaca, NY (US); John E. Tarbotton, Ithaca, NY (US); William M. Schmid, Auburn, NY (US)

Correspondence Address: George R. McGuire;Bond, Schoeneck & King, PLLC, One Lincoln Center, Syracuse, NY, 13202, US

(21) Appl. No.: 10/936,397

(22) Filed: Sep. 8, 2004

Related U.S. Application Data
(60) Provisional application No. 60/501,198, filed on Sep. 8, 2003.

(51) Int. Cl. B41J 1/00

(52) U.S. Cl. 358/1.9

(57) ABSTRACT

POS printer software architecture for merging multiple graphical objects with standard printed data to improve the visual addition of content. The real-time merging of graphics with the legacy output of POS printers begins with the receipt of legacy data into the printer buffer, active merge sources are retrieved, the merge source pixels are added into the raster data, the merge source counters are updated, a check is made to verify that all active merge sources have been added, and the raster line is sent to the printer for printing the combined legacy output and graphics.

### CROSS-REFERENCE TO RELATED APPLICATIONS

The present application claims priority to U.S. Provisional Application Ser. No. 60/501,198 of the same title, filed on Sep. 8, 2003, and hereby incorporated by reference.

### BACKGROUND OF THE INVENTION

1. Field of Invention

The present invention relates to point-of-sale printers and, more specifically, to printers capable of merging multiple graphical objects with legacy text.

2. Description of Prior Art

The graphics capabilities of point-of-sale (POS) printers are generally defined by each respective manufacturer's command set. Conventional printers are usually able to store a bit image of no more than a few inches in height and length, i.e., a “logo,” and then print the logo on command. Such bit images have traditionally been stored in the printer due to the communication speed limitations of the host—printer interface.

The ability to print a logo repeatedly is the result of the retailer's need to distinguish their printed receipts from that of others. The proliferation of color images in modem business-to-consumer interfaces has resulted in a marketing trend/campaign to entice consumers with bit image messages at every encounter. Conventional logo POS printers fall far short, however, of their potential supportive role to these business needs.

A POS printout, e.g., a receipt, contains different types of data. More technically, a receipt is comprised of print instances that belong to different classes of objects or bit images. There are four recognized types of bit objects: text characters, barcodes, logos, and single or character width rasters of bits that can be the parameter of a command. Operations on the text objects include storing user created characters, applying certain attributes (bold, italics, underline, shade) and size transformations before printout. The only prior art operations defined for a logo, aside from storing it in the first place, is to print it at regular or various intervals and with magnification and/or various justification.

Additional POS printer capabilities have been accomplished by, in a limited way, decoupling the constraints imposed by unidirectional paper movement from those of a serial command sequence. This was done by providing a defined memory area where a receipt could be constructed via out-of-linear-sequence placement of the objects, and then printing that composite object, similar to the output of an office page printer. Not surprisingly, this was called page mode. Size limitations and difficulty in use, as well as printer host application advancements and POS printer speed improvements, have made page mode practically obsolete.

More general and unconstrained capabilities are required to handle the current and new objects in a POS printer. These applications adhere to the unique characteristics that distinguish this type of printer from office printers—high speed with narrow width and indeterminate length (roll) paper verses a fixed page size.

FIG. 1 illustrates the general input-process-output model 10 that is the basis of most prior art receipt printing processes, with a POS printer distinctive addition of an intermediate object store. The presence of buffers at the receive and output steps referred to as input/receive buffer 12 and raster/print 14, respectively, indicate that the tasks of input, processing, and output (the actual printing) can go on virtually simultaneously. As all buffers may be multiples, there are many options in actual implementation, ranging from operating system managed queues to home-brewed producer-consumer algorithms working on dedicated areas of buffer memory. For example, multiple print buffers 14 could exist in a POS hybrid printer, where one print buffer 14 is dedicated for receipt usage and another buffer 14 for slip (including check endorsement) or journal printing. The arrows indicate that some sort of a signal is needed to tell the lower tasks to look for more work; which could, of course, also be implemented by the task looking into the (next) buffer space for the arrival of more work. Typically, the buffers are managed by command and data processor(s) 20 which, in turn, communicate with the print head and paper advance controls 22 to effect the printing of a POS receipt. Not shown in FIG. 1 is the flow back to indicate that the buffer content has been processed and the buffer space freed for subsequent usage.

Significant sophistication exists in the input/output controller interface 16, which has to solve the sharing of the input stream by commands and parameters (which can include appended bit images), and text print characters in an unstructured fashion—i.e., the commands and the print data are intermixed. Additional complexity exists due to the non-deterministic characteristic of potential “immediate” commands that may be found in the input stream. These immediate commands are usually of the control or error recovery type and, as their name implies, are executed ahead of any other ongoing task or previously queued commands. The commands are described as indeterminate because the generating host of the input stream may place them within sections of bit graphics data, and there is no way for the printer to tell if the intent was bit data or immediate command. A plurality of controllers 16 have been shown in FIG. 1 as there may be more than one, since POS printers have to handle immediate commands and some printer models are built with multiple I/O interfaces. A plurality of print head and advance controllers 22 are also referenced to cover hybrid printers that have two or more print stations, thus allowing different actions to be taken that are appropriate to the actual print technology being controlled. For example, a thermal printer and an impact printer are a popular combination, each requiring different print head control.

Conventional printers have some object store 18 capabilities. These include the ability to store: a macro string as a user defined input sting that can later be referenced as the function sequence of the macro command; a user defined character cell bit image that allows users to make up their own character shapes; and logos or bit image graphics normally made to fit the size of paper used by a POS printer. When these stored objects are later selected (by explicit commands for the macro or logo, and via indirect reference for text characters from the input data), the result is processing the macro content as if it were input and the printing of characters or logos for the bit image objects. One additional graphical capability of some POS printers has been to create the bit image required for forming a barcode dynamically in any of the various physical formats that barcode standards have defined. An algorithm is usually applied to build a bit image “on the fly” as part of executing the barcode command.

There is seen in FIG. 2, the graphic printing process 30 of a prior art POS printer. The input buffer 12 feeds directly to the print raster buffer 14 (right side) for processing for a conventional graphic print command, such as “print raster graphic.” An alternative embodiment is to perform all print image formation in the host computer (by doing all the command processing and raster bit formation in a “filter” driver); this is the one printing function that the printer needs to implement. The page buffer 32 is a prior art capability in some POS printers where, instead of processing print commands into print buffer 14, they are instead processed into page buffer 32 first and then a command to print the “page” is used to move the results into print buffer 14. This method is a size restricted way that an application can make printouts which otherwise would have required a print, reverse paper feed and reprint sequence, which gives very poor results on thermal paper and so is not generally done.

Conventional barcode formation 34 is depicted as a “detour” instead of a direct graphics input from input buffer 12. The bit image of a barcode is formulated and issued as if it were a sequence of print raster graphics commands. While the details of how to form the sequence of barcode rasters are complex, the process is well known in the art. Conventional graphic print processes may involve sending specialized, pre-formulated print data to print buffer 14 from logo memory 36 or from character font memory 38.

Conventional POS printers fall short in that the printout often appears more like the output of an adding machine or cash register with an occasional stamped merchant logo or special font. The quality of home and office raster graphics printers and Web browser displays have raised customer expectation, however, and have driven the need to provide more outlets for customer loyalty messaging and in-house and goods supplier/manufacturer marketing.

A related foray into a limited combination of graphics and text printing has come from an allied printer field, that of label printers. Label printers add background image formation to label text printing, possibly saving some cost of using pre-printed label media by generating the background as they go. For example, U.S. Pat. No. 5,947,619 discloses a method to make a repeating tile graphic as a full width background in a label printer context, but does not detail how the background and label text are combined. Such detail is only hinted at in U.S. Pat. No. 6,062,750, where the combination is described as a visual “adding” and performed by a computation OR of the bits from the repeating background pattern buffer and the input text. This reference further shows how to create a “frame” bounded pattern within which the text that is printed. While these references show how to get a singular (and from a command perspective, static) background to be printed with incoming text data, they do not show different multiple graphics objects and flexible control.

In conventional POS printers, one can print either a line of text (with some characters being a large size), or a previously saved logo bit graphic, or the content of a constructed bit image done during “page mode” printing, or a raster line directly out of the communication interface input buffer. There are existing printer commands for all of these actions. Pulling text characters out of the printer's font memory is really an indirect or hidden command that comes from the input processing rule that states if the input is not a recognized command followed by its parameter(s), then the input is to be treated as references to text character bit patterns. For example, a hex “41” in the input stream means the formation of a “A” pattern (in the current font) at the next character position in the print buffer. Which source is active at any one time is decided based on the command received, and when there is a source switch it is sometimes necessary to complete a text line with blanks and print it out before the switch can take place.

### OBJECTS AND ADVANTAGES

It is a principal object and advantage of the present invention to provide a POS system and method for merging background graphics with incoming text.

It is an additional object and advantage of the present invention to provide a POS system and method for printing dynamic, multiple graphic effects.

It is a further object and advantage of the present invention to provide a POS system and method of printing that includes a set of easy to use commands.

Other objects and advantages of the present invention will in part be obvious, and in part appear hereinafter.

### SUMMARY OF THE INVENTION

The present invention comprises a new POS printer software architecture that allows multiple graphical objects to be merged with standard printed data to improve the visual addition of content. The real-time merging of graphics with the legacy output of POS printers is accomplished by receiving legacy data into the printer buffer, retrieving active merge sources, adding merge pixels into the new raster data, updating merge source counters, verifying all active merge sources have been added, and sending the raster line to the printer.

### BRIEF DESCRIPTION OF THE DRAWINGS

FIG. 1 is a high-level flowchart of the prior art POS printing process.

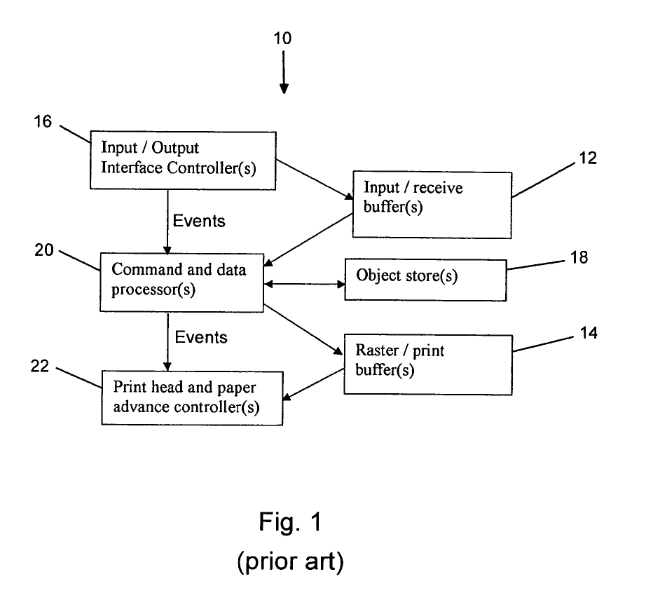

FIG. 2 is a high-level flowchart of the prior art POS graphic printing process.

FIG. 3 is a high-level flowchart of a POS graphic printing process according to the present invention.

FIG. 4 is a intermediate-level flowchart of the graphic merge process according to the present invention.

FIG. 5 is a low-level flowchart of the graphic merge process according to the present invention.

### DETAILED DESCRIPTION

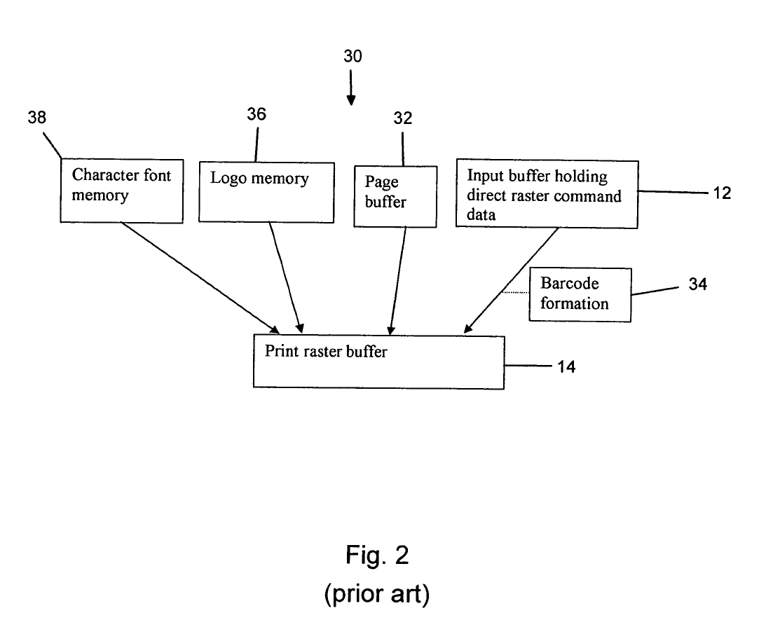

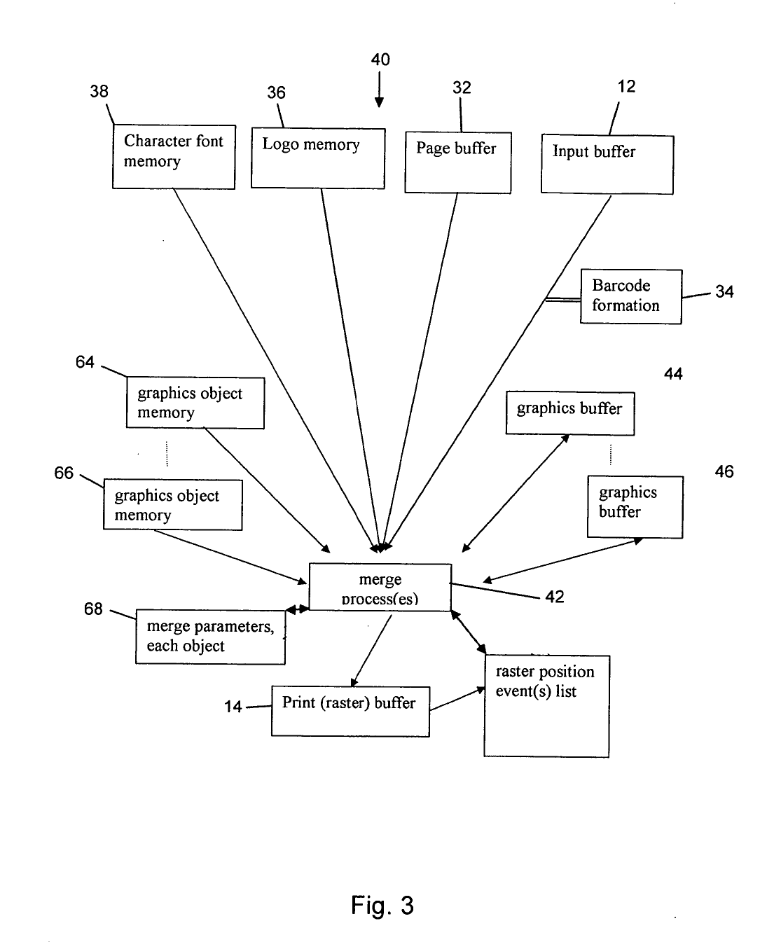

Referring now to the figures wherein like numerals refer to like parts throughout, there is seen in FIG. 3, the graphic merge print process 40 of the present invention. Print process 40 combines multiple, concurrent sources that are added together visually on a pixel-by-pixel basis in a merge process 42. Prior art legacy functionality and behavior are preserved, but the capabilities of a POS are dramatically enhanced by visually adding graphic images from one or more graphic buffers 44 and 46 as each raster line is filled with legacy print data. Thus, the conventional single source at a time feeding of the print buffer of a prior art printer is combined with multiple concurrent sources that are dynamically added together on a parameterized basis during merge process 42. The preservation of prior art POS printer functionality is evident in FIG. 3 from the carry over from FIG. 2 of the various prior art print sources, i.e., character font memory 38, logo memory 36, page buffer 32, or input buffer 12. Instead of filling print raster buffer 14 directly, however, the prior art print sources first undergo merge process 42.

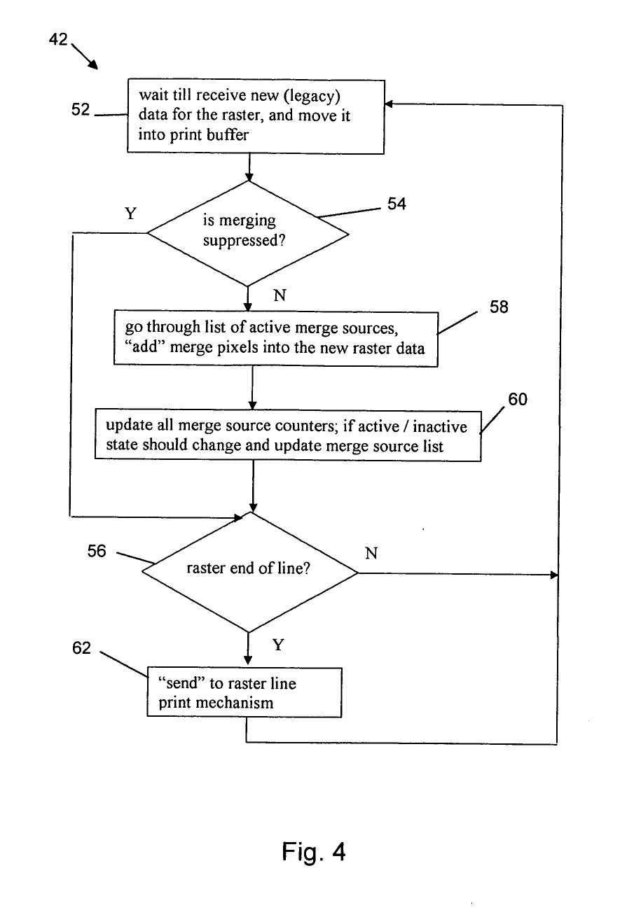

As seen in FIG. 4, the first step of merge process 42 of the present invention involves receiving 52 the new (legacy) print data into the print raster. In other words, merge process 42 begins by waiting for legacy type input data in final form, i.e., pixel raster data. Once new data is received 52, a decision 54 is made whether merging is suppressed. If yes, control passes to end of raster line check 56 for determining whether the raster line input has concluded. If merging is not suppressed, the list of active merge sources is reviewed and any applicable source pixels are merged 58 with the received raster data. Thus, merge process 42 performs the visual add operation (usually a logical OR of the pixels). In certain cases, such as bar code printing, the merging of any other data should be suppressed to achieve maximum readability. This is done by using a suppression switch. Otherwise, all active merge sources have their respective data ORed with the legacy print data. Once merging 58 is complete, the merge counters are updated 60 so that the status of each merge source is accurate.

After a determination that merging is suppressed 54, or after updating of merge counters has completed, a determination is made whether the raster end of line 56 has been reached, If not, control passes back to receiving new data 52. If raster end of line 56 has been reached, the merged raster line is sent 62 to the print mechanism for printing.

Color or monochrome graphics can be merged with single tone images, or if the legacy input is text, character attributes (which may dictate the color of the character) are applied to form a bit graphic that may also carry color information. Depending on the printer model and loaded media, in this process if the output is monochrome, any coloring data may have to be discarded or replaced by grayscale, thus transforming all color data into either black or white pixels. Although a text character is normally a single color, color-specified text strike through has recently been introduced. The strike through and its specified color is a fixed relative position, easily calculable, solid bar figure that is merged into the character cell after it is placed in the raster buffer.

As seen in FIG. 3, merge process 42 can also handle pre-set graphics objects, such as watermarks, that are stored in one or more graphic object memories 64 and 66, as well as created graphics, such as a surround shapes, in one or more graphics buffers 44 and 46.

All graphics are added visually as the raster line is filled from the current source of (legacy) print data during merge process 42. Legacy standard printing of data is raster position counted, and additional merges into this data are determined by predetermined merge parameters 68 for each object and the list of raster position and count events that trigger further merge action repetitions. This list serves as a dynamic feedback mechanism, which is updated every time one of the merge sources completes. There can be one or more persistently stored bit graphics objects in graphics object memory 64 or 66 (such as in Flash memory) destined for merging that are already in raster form. These objects can be retrieved directly from memory 64 or 66 (assuming reading Flash is fast enough) at the time print raster 14 is filling with new pixel data. In addition, there can be one or more created bit images in RAM graphics buffers 44 and 46 that are also added in as the raster line is built up. For example, a mathematically generated surround boarder shape, such as an ellipse or rectangle, can be added. An intermediate buffer may be needed for representation transforms, such as a compressed image that needs to be decompressed before being used in merge process 42.

Certain created bit images or required transforms may be done “on-the-fly,” i.e., without using an intermediate buffer, if the math for the shape can be coordinated with raster position counters. This is a tradeoff between memory (where the shape is formed before it is used) and computation (deciding if a particular pixel should be shown or not in that spot on the shape); it is preferred to use POS printer memory rather than taxing its processor if speed is of concern. The merge process can also be used to first build up a bit image in a graphics buffer rather than directly in the print buffer and then print by feeding it to the print buffer.

Which memory objects and graphics buffer(s) are actively added together at any time is controlled by acting on merge parameters 68 associated with each object/buffer. Merge parameters 68 are the set of instructional flags/processing counters and pointers for going from left to right at each raster line, and for going down the raster lines until the bit image has been used up. The following parameters are preferably set for the merge process of each memory object and graphics buffer:
start raster position—this is the pixel offset from the left side;
width in pixels—this could also be expressed as an end count pixel;
start height count—this is the raster height offset from a framing perspective;
height number of rasters—this is the height of the merge bit image;
destination buffer—another graphics buffer or the print raster buffer;
color/image encoding flag—covers object format to raster mapping such as monochrome image to color raster or decompressing image on-the-fly;
repetition count;
pause distance expressed as a raster line count; and
justification—left, centered, right, alternating left-right, alternating right-left, left and right doubling image (i.e., equals same image on both sides)

Some of these values could be known constants or defined by the intrinsic characteristics of static objects. For example, to create a “left side inch marker” bit image object designed for margin placement, the raster start position would be 0, width 50, the number of rasters would be 200 for a 200 raster per inch paper advance mechanism, and the color would be black. All of these properties are implemented as constants rather than being defined values by a dynamic command.

The repetition count/distance parameter is used to set an automatic clear spacing between re-application of this merge for the repetition count number of times. A value of zero indicates one-time usage.

Since all of its merges are concurrent with prior art printing, the result is visibly additive rather than a destructive overwrite. As the printer is unaware of any unintended information destruction, the design of the different bit images and their intended placements must take into account the potential final results and bit images of the right size, visual density, and placement must be constructed.

Merge bit images can either be created by some algorithmic means or acquired from object memory store. When created, command arguments are used for any merge process parameters that are not constants for that particular object type. When acquired from memory, the merge parameters are filled in from the command sent parameter values and known constants when the object was first stored.

Bit image object properties should contain at least the following information (some of these properties can be constant values that are part of the object class):
object class id—this distinguishes bit images by their intended usage, and may be an attribute of the storage space in which it is placed if class specific storage areas are designated or set aside;
memory id—location in memory. In fixed allocation memory schemes, this is an index of size and encoding values—some of these are constants within a class.
role ID—this allows selected bit images to be designated for canned (rather than command invoked) repetitive printing. Doing this at printer configuration or infrequent download times sets up the printer for graphics actions that the using application is unaware of.
quasi unique identifier—such as the bit image CRC, for reporting purposes; which may be omitted if the printer does not need such reporting.
merge process attributes (set from the parameters defined above).
merge override switch—certain objects are best printed in the clear, with no other merge action taking place. This is mostly used to protect certain prior art bit images such as bar codes.

Notice that the preceding explanation is introducing the idea that current software object methodology is an alternate way for implementing this discovery. In this case, the merging is done from the point of view of each object merged. A flowchart of the method in each such object follows; copies (process threads) of this method are concurrently executed for all objects that are participating in a merge.

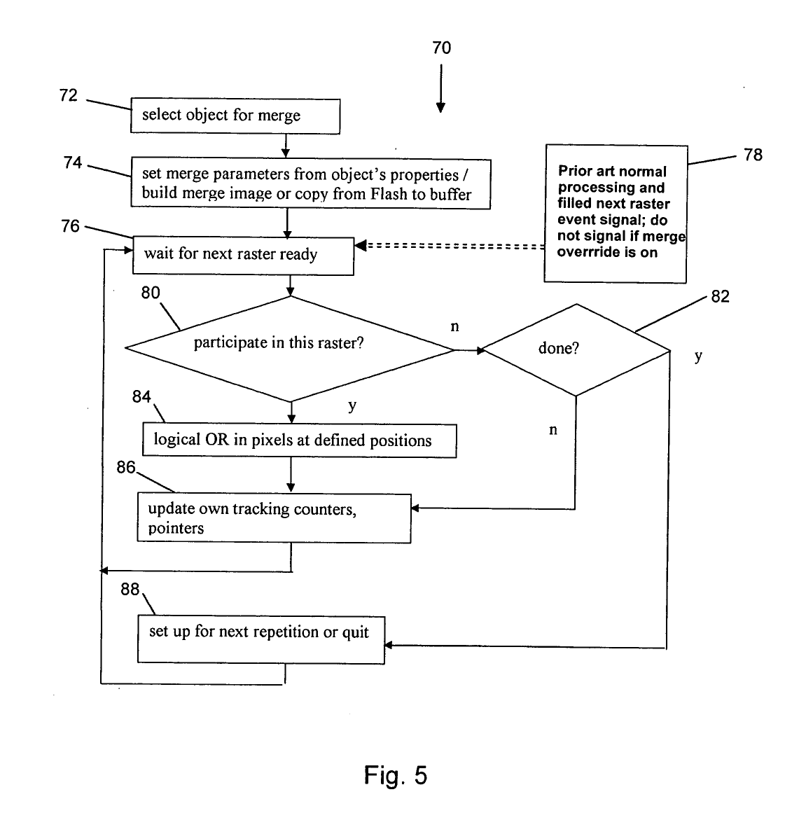

As seen in more detail in FIG. 5, merge process 70 is initiated by a triggering event, such as a command selecting an object for merge 72, or other event. Once initiated 72, the merge parameters are set 74 and the object to be merged is built or expanded into a buffer. Merge process 70 next waits 76 for receipt of the conventional next raster ready signal 78. Inserted into prior art normal processing is an issuing of a message notifying that the next raster line (in the print buffer) is about to be released for printing. Once signal 78 is received, a decision is made whether the selected object is supposed to participate in the raster 80 based on the value of each merge process counter.

If an object is not supposed to be merged in the current raster line, a check is made to see whether the current raster is done 82. If not, the counters are updated 86 and control returns to wait 76 for next raster ready signal 78. If merging is supposed to occur, the bit image data is “ORed” 84 with the content already in the raster line and the counters and/or pointers are updated 86. If the end of the merge object is reached, then the process repetition count and quiescent parameter 88 is used to decide if counters should be reset to start again or that this merging is complete.

It is possible to restructure the flow in FIG. 5 so that the merge into the raster is done first and then the legacy raster information is ORed in, or some complex combination of all the sources, as the order of servicing all of the current merges should be chosen from implementation performance concerns.

Thread or task signaling is accomplished by conventional processes using standard operating system (OS) functions, such as a count semaphore. With thread or task signaling, printing operations must wait until all the merge processes are done with that line before feeding it to print head control. Alternatively, this step could be accomplished by a roll-your-own mechanism for printer firmware that is not based on a commercial OS or kernel offering.

Several POS printer functions are used for the implementation of the present invention and should be incorporated into the standard command interpreter. A list of function commands follows.

| | |
|---|---|
| Command: | Create graphics buffer |
| Parameters: | Size (a 0 value indicates release of the buffer memory); buffer reference ID (this |
| | specifies the buffer in later use), returns buffer ID |
| Function: | Reserves/releases dynamic memory space for merging use; sets any buffer |
| | properties to initial values. This is a standard software engineering function |
| | applied to POS printers. The returned buffer ID is a value that cannot conflict with |
| | any logo IDs - see the Assign logo role command below. |
| Command: | Merge graphics buffer |
| Parameters: | buffer reference ID, start-restart/pause/stop switch |
| Function: | Starts or continues (after a pause) or pauses or stops the addition of this buffer's |
| | content to the merging process. Note that the merge parameters mentioned earlier |
| | in the disclosure have been set when a graphic object is moved into the buffer. |
| | This is a unique function for POS printers. |
| Command: | Use page buffer as one of the active merge buffers |
| Parameters: | On/Off switch; merge parameters |
| Function: | The bit graphic that is in the page buffer will be use for merging. As prior art |
| | implementations did not have two properties that merge objects have, these are |
| | part of the parameters sent with the command. Since the page buffer is a prior art |
| | object, it can override any other active merging sources. Use of the page buffer as |
| | a merge source is an invention of this disclosure. |
| Command: | Set color to grayscale mapping |
| Parameters: | Buffer reference ID or 0, % shading |
| Function: | Sets, for the identified buffer, or all buffers if the reference = 0, the shading action |
| | that should be used to replace any colored (other than black) portions of an image. |
| | A zero value for shading indicates to use the printer's implementation default |
| | value. |
| Command: | Suspend all merging |
| Parameters: | None |
| Function: | Pause all merging activity. |
| Command: | Restart all merging |
| Parameters: | None |
| Function: | Proceed normally with merging activity. |
| Command: | Select overriding merge buffer |
| Parameters: | On-off switch, buffer ID |
| Function: | Turns on or off the use of only one designated buffer in the merging process |
| Command: | Define abstract logo role |
| Parameters: | Abstract logo ID, merge parameters |
| Function: | Sets up a merging activity to be assigned to a real logo, such a top logo |
| Command: | Assign logo role |
| Parameters: | logo ID, abstract logo ID, buffer ID, priority |
| Function: | Identify a particular logo to the designated role. The priority value allows for more |
| | than one graphic to act in a role, to select which gets printed first if the abstract |
| | role is the same, such as when multiple logos are printed at the bottom of a |
| | receipt. If the buffer ID is the same as the logo ID, then this simply sets the |
| | merging parameters to use the logo directly from its flash memory location. This |
| | dynamic control can change the printed image(s) on a receipt without requiring |
| | the communication-speed-limited downloads needed to change the group of logos |
| | that are actually printed in the prior art way. |

1. A method of printing on the output media of a computer output device adapted to receive an input byte stream, said method comprising the steps of:
(a) receiving a command in said input byte stream which indicates a graphic object for merging with said line of print data;
(b) loading said graphic object into a buffer;
(c) receiving a raster line of print data in said input byte stream into a buffer; and
(d) merging said graphic object with said raster line of print data in said buffer to form a merged raster line.

2. The method of claim 1, further comprising the steps of:
(f) repeating steps (c) and (d) until all of said graphic object has been merged with said input byte stream.

3. The method of claim 1, wherein more than one graphic is merged with said input byte stream.

4. The method of claim 1, wherein said computer output device comprises a point-of-sale printer.

5. The method of claim 1, wherein said output media comprises a receipt.

6. The method of claim 1, wherein said graphic object is a top logo, bottom logo, margin message, watermark, or surround graphic.

7. The method of claim 1, wherein said step of merging said graphic object with said raster line of print data comprises the visual addition of each bit of said graphic to each bit of said raster line of print data, wherein darker tones override lighter ones.

8. The method of claim 1, wherein multiple graphic objects are simultaneously merged with said raster line of print data.

9. A point-of-sale printer adapted for receiving an input byte stream from a host application having memory and an input stream command interpreter, said printer comprising:
(a) an intermediate buffer for receiving a line of print data in said input byte stream;
(b) a graphic object stored in said memory;
(c) means for retrieving said graphic object in response to a command from said host application; and
(d) means for merging said graphic object with said line of print data in said intermediate buffer.

10. A method for establishing abstract roles for one or more persistently stored graphical objects, comprising the steps of:
(a) dividing an output media template into top, bottom, watermark, and margin message regions;
(b) associating each said region with a persistent graphical space;
(c) receiving role designated graphical objects in said input byte stream; and
(d) storing said received graphical objects and associating them with said persistent graphical spaces.

11. A method for merging a stored graphic object with an output byte stream of a host application including a text print portion, said method comprising the steps of:
(a) designating at least one said stored graphical object to be merged with said text print portion;
(b) merging said stored graphic object with said text print portion on the basis of a repetition count; and
(c) performing said merge and achieving a non-merged quiescent space of the designated length.

12. The method in claim 10 where more than one said stored graphical object is said merged under its own said repetition count and said quiescent space values.

13. A point-of-sale printer adapted for receiving an input byte stream from a host application and having memory and an input command interpreter, said printer comprising:
a raster line interface interconnected to at least one print head controller;
means for optically merging two or more printable objects into a sequence of raster lines; and
wherein said command interpreter is programmed to execute commands defining merge parameters that control the size, placement, repetition count, and repetition distance of said printable objects.

14. The device of claim 12, wherein said sequence of raster lines are placed in an intermediate buffer rather than going directly to a print raster.

15. The device of claim 12, wherein said raster line interface is programmed to optionally convert said printable objects into monochrome.

16. The device of claim 12, wherein said means for optically merging two or more printable objects uses a counted-down cyclic process.

17. The device of claim 12, wherein said means for optically merging two or more printable objects uses independent, virtually concurrent processes for each said printable object to be merged.

18. The device of claim 12, wherein merging activity can be suspended or resumed.
